(19) United States
(12) Patent Application Publication
(10) Pub. No.: US 2025/0260449 A1
(43) Pub. Date: Aug. 14, 2025

(54) METHOD, DEVICE AND COMPUTER STORAGE MEDIUM OF COMMUNICATION

(71) Applicant: NEC CORPORATION, Tokyo (JP)

(72) Inventors: Peng GUAN, Beijing (CN); Yukai GAO, Beijing (CN); Gang WANG, Beijing (CN)

(73) Assignee: NEC CORPORATION, Tokyo (JP)

(21) Appl. No.: 18/856,376

(22) PCT Filed: Apr. 15, 2022
(86) PCT No.: PCT/CN2022/086995

§ 371 Date: Oct. 11, 2024

(51) Int. Cl. H04B 7/06

(52) U.S. Cl. CPC H04B 7/0626

(57) ABSTRACT

Embodiments of the present disclosure relate to methods, devices and computer readable media for communication. A terminal device determines CSI based on a measurement on a set of RSs from a network device, and determines a compression method based on a configuration from the network device. The terminal device compresses the CSI based on the compression method, and transmits, to the network device, the compressed CSI. The network device determines the compression method applied for the compressed CSI based on the configuration, and recoveries CSI based on the compressed CSI and the compression method. In this way, CSI feedback overhead and compression performance may be balanced.

### TECHNICAL FIELD

Embodiments of the present disclosure generally relate to the field of telecommunication, and in particular, to methods, devices and computer storage media of communication for an artificial intelligence (AI) or machine learning (ML) based channel state information (CSI) feedback.

### BACKGROUND

Currently, a codebook based CSI feedback is supported, including type I single panel codebook, type I multi-panel codebook, type II codebook, type II port selection codebook, enhanced type II codebook, enhanced type II port selection codebook, and further enhanced type II port selection codebook. As known, overhead of CSI feedback is a major concern. It is agreed that an AI or ML based method may provide significant overhead reduction. However, details of an AI or ML based CSI feedback are still incomplete and need to be further developed.

### SUMMARY

In general, embodiments of the present disclosure provide methods, devices and computer storage media of communication for an AI or ML based CSI feedback.

In a first aspect, there is provided a method of communication. The method comprises: determining, at a terminal device, channel state information based on a measurement on a set of reference signals from a network device; determining a compression method based on a configuration from a network device, the configuration comprising at least one of the following: a time-domain parameter, a frequency-domain parameter, or a spatial-domain parameter; compressing the channel state information based on the compression method; and transmitting, to the network device, the compressed channel state information.

In a second aspect, there is provided a method of communication. The method comprises: transmitting, at a network device and to a terminal device, a configuration comprising at least one of the following: a time-domain parameter, a frequency-domain parameter, or a spatial-domain parameter; receiving compressed channel state information from the terminal device; determining a compression method applied for the compressed channel state information based on the configuration; and recovering channel state information based on the compressed channel state information and the compression method.

In a third aspect, there is provided a terminal device. The terminal device comprises a processor configured to cause the terminal device to perform the method according to the first aspect of the present disclosure.

In a fourth aspect, there is provided a network device. The network device comprises a processor configured to cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating an example process of an AI or ML based CSI feedback in which some embodiments of the present disclosure can be implemented;

FIG. 3 illustrates a schematic diagram illustrating a process of communication according to embodiments of the present disclosure;

FIG. 4A illustrates a schematic diagram illustrating an example determination of a compression method according to embodiments of the present disclosure;

FIG. 4B illustrates a schematic diagram illustrating another example determination of a compression method according to embodiments of the present disclosure;

FIG. 5 illustrates an example method of communication implemented at a terminal device in accordance with some embodiments of the present disclosure;

FIG. 6 illustrates an example method of communication implemented at a network device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

It is observed that as an AI or ML model, an autoencoder or transformer based CSI feedback is to compress CSI at user equipment (UE) and to recover the CSI at a network (NW). Some of key parameters of the AI/ML model may include an input/output dimension, a compression method and a quantization method, etc., and may need to be aligned at both NW and UE side.

It is also observed that, by exploiting time-domain correlation, with the same compression ratio, better compression performance is obtained. In other words, to achieve the same compression performance, less bits are needed to compress CSI, at least within a coherent time window. Similarly, by exploiting frequency-domain correlation, to achieve the same compression performance, less bits are needed to compress CSI. By exploiting spatial-domain correlation, to achieve the same compression performance, less bits are needed to compress CSI.

Within a third generation partnership project (3GPP) CSI feedback framework, it is to be addressed how to exchange information required to align parameters of an encoder and a decoder, and support an adaptive compression method considering time-domain, frequency-domain or spatial-domain correlation.

In view of this, embodiments of the present disclosure provide a solution of communication for a CSI feedback so as to overcome the above or other potential issues. In this solution, a terminal device determines a compression method based on a configuration from a network device to compress CSI, and transmit the compressed CSI to a network device.

A network device determines the compression method based on the configuration and recoveries CSI based on the compression method and the compressed CSI. In this way, a dynamic compression method may be applied to obtain compressed CSI based on a configuration from a network device. Accordingly, CSI feedback overhead and compression performance may be balanced.

For convenience, definitions of some terms in the present disclosure may be listed as below.
The terms “a compression method” may refer to at least one of the following parameters: a compression ratio (CR), the number of compressed bits, the number of quantization bits, output or input dimension of encoder, output or input dimension of decoder, the number of layers in an encoder or decoder, dimension or size of each layer, activation function, and so on. Each of these parameters may be set per frequency unit, per time unit or per spatial unit. For example, for a CR, a CR per frequency unit refers to the number of compressed bits per sub-band, per PRB, etc., A CR per time unit refers to the number of compressed bits per slot, per frame, etc., A CR per spatial unit refers to the number of compressed bits per port, per beam, etc..
The terms “a CR” may refer to one of the following definitions:
   Definition 1: CR=output dimension of encoder/input dimension of encoder. For example, the input dimension of encoder may refer to the number of ports X the number of sub-bands, and the output dimension of encoder may refer to the number of compressed bits or the number of compressed bits/the number of quantization bits;
   Definition 2: CR=2×output dimension of encoder/input dimension of encoder. 2 may stand for real and imaginary part of a complex value. 2 may stand for dual polarizations. 2 may also be replaced by other constants;
Definition 3: CR=the number of quantization bits X output dimension of encoder/input dimension of encoder;
Definition 4: CR=2×the number of quantization bits×output dimension of encoder/input dimension of encoder;
   Definition 5: CR=the number of bits required to report codebook-based CSI/the number of bits required to report compressed CSI. The codebook-based CSI may refer to type I single panel codebook, type I multi-panel codebook, type II codebook, type II port selection codebook, enhanced type II codebook, enhanced type II port selection codebook, and further enhanced type II port selection codebook;

The expression “a higher compression ratio” in the present disclosure means less bits to compress the same amount of information, i.e., CR1=¼ is a higher comparison ratio compared to CR2=½. But in terms of the value of the fractional number, CR1<CR2. In other words, “CR1<CR2” means “CR1 is a higher compression ratio than CR2” and “with CR1, less bits are required to compress the same amount of information”;
CR may be not a specific value of CR and may be an index value indicating CR. For example, CR index 1 may correspond to ½, CR index 2 may correspond to ¼, etc.;
CR may comprise no compression. For example, CR index 0 may correspond to “no compression”.
The terms “quantization information or method” may refer to at least one of the following:
   The number of quantization bits, such as 1-bit, 2-bit, 4-bit, etc.;
   The method of quantization, such as uniform quantization, non-uniform quantization;
   A ceil, floor or round operation applied in quantization function, such as ceil/floor/round value of (x×2^{(B-1)})/(2^{(B-1)}) if B-bit uniform quantization is used;
   If the total number of compressed bits is fixed, the higher compression ratio means more bits for quantization;
   The quantization information may be not a specific value and may be an index value indicating the quantization information. For example, quantization index 0 may correspond to 1-bit quantization, quantization index 1 may correspond to 2-bit quantization, etc.,
The terms “quantization information or method” may refer to at least one of the following:
   The number of quantization bits, such as 1-bit, 2-bit, 4-bit, etc.;
   The method of quantization, such as uniform quantization, non-uniform quantization;
   A ceil, floor or round operation applied in quantization function, such as ceil/floor/round value of (x×2^{(B-1)})/(2^{(B-1)}) if B-bit uniform quantization is used;

If the total number of compressed bits is fixed, the higher compression ratio means more bits for quantization.
The terms “channel quality” or “channel quality information” may be associated or reflected with at least one of the following measurement/report matrices: a rank indicator (RI), a channel quality indicator (CQI), a signal noise ratio (SNR), reference signal receive power (RSRP), a signal interference noise ratio (SINR), a received signal strength indicator (RSSI), reference signal receive quality (RSRQ), and supported or reported or scheduled modulation and coding scheme (MCS), supported or reported or scheduled modulation scheme, supported or reported or scheduled coding rate, supported or reported or scheduled efficiency.
The terms “UE capability reporting” may comprise at least one of the following:
   Supported number of bits for a precoder matrix indicator (PMI)/CSI report for auto-encoder based CSI feedback, candidate value is (52, 104, 208, 312, etc.), in general, an integer number, smaller than the codebook based CSI feedback;
   Supported compression ratio, candidate value is (½, ¼, ⅛, 1/16, etc.), in general, a fractional number;
   Supported quantization methods. For example, candidate value is (1, 2, 3, 4, etc.), in general, an integer number, if quantization information is the number of quantization bits; or
   Supported input dimension of encoder, in other words, supported number of ports for auto-encoder based CSI feedback, support number of sub-bands for auto-encoder based CSI feedback, support size of sub-bands for auto-encoder based CSI feedback, support bandwidth for auto-encoder based CSI feedback.
The terms “CSI report configuration” may comprise at least one of the following:
   Report quantity: (NW configures UE to report one or many of) compressed CSI/PMI, compression ratio, quantization method, and at least one of the following:
      CRI, RI, LI, PMI, CQI, wideband/subband PMI, wideband/subband CQI, wideband/subband amplitude/phase, wideband/subband co-phasing, index or linear combination of spatial/frequency/time-domain discrete Fourier transform (DFT)/discrete Cosine transform (DCT) basis;
      SNR, RSRP, SINR, RSSI, RSRQ, supported modulation scheme, supported coding rate, supported efficiency;
      type I single panel codebook, type I multi-panel codebook, type II codebook, type II port selection codebook, enhanced type II codebook, enhanced type II port selection codebook, and further enhanced type II port selection codebook;
      transform-domain of CSI, including spatial-frequency domain, time-frequency domain, angular-delay domain, etc.;
   Compressed CSI/PMI may comprise a channel compression in a transform-domain including spatial-frequency domain, time-frequency domain, angular-delay domain, etc.;
   Time-domain and frequency-domain information, PUCCH/PUSCH resources for the CSI report; or
   CSI-resource for measurement.
The terms “AI/ML model configuration” may comprise at least one of the following:
   Start/end (or, activation/deactivation) of AI/ML model training/inference (or, report compressed bits for CSI/PMI report);
   AI/ML model information: auto-encoder-based CSI feedback, transformer-based CSI feedback, or other types of AI/ML model such as multilayer perceptrons (MLPs), convolution neural networks (CNNs), and recurrent neural networks (RNNs) and so on;
   Auto-encoder information or transformer information comprising at least one of the following:
      Supported number of bits for PMI/CSI report for auto-encoder based CSI feedback, candidate value is (52, 104, 208, 312, etc.), in general, an integer number, smaller than the codebook based CSI feedback;
      Supported compression ratio, candidate value is (½, ¼, ⅛, 1/16, etc.), in general, a fractional number;
      Supported quantization methods. For example, candidate value is (1, 2, 3, 4, etc.), in general, an integer number, if quantization information is the number of quantization bits;
      Supported input dimension of encoder, in other words, supported number of ports for auto-encoder based CSI feedback, support number of subbands for auto-encoder based CSI feedback, support size of subbands for auto-encoder based CSI feedback, support bandwidth for auto-encoder based CSI feedback;
   Other parameters and hyper-parameters to describe AI/ML model (or, to align encoder/decoder) including a number or a maximum number of layers, a number or a maximum number of hidden layers, layer types, layer shapes (i.e., filter size, a number of channels/filters), a number and a maximum number of neurons per each layer, a number and a maximum number of neurons, and connections between layers, learning rate, loss function, cost function, activation function, mini-batch size, number of training iterations, momentum, number of hidden units, weight decay, activation sparsity, nonlinearity, weight initialization, regularization constant, number of epochs, number of branches in a decision tree, number of clusters in a clustering algorithm and any other hyper-parameters.
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably.
The terms “group”, “subset” and “set” may be used interchangeably.
The terms “relationship”, “mapping” and “correspondence” may be used interchangeably.
The terms “recovery”, “decode” and “decompress” may be used interchangeably, and the term “encode” and “compress” may be used interchangeably.
The terms “compressed CSI”, “compressed PMI” and “compressed CSI/PMI” may be used interchangeably.
One panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” may be used interchangeably.
Panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID.
The term “network”/“network device(s)” refer to one or more network devices. Accordingly, terms “network”, “network device(s)” and “one or more network devices” may be used interchangeably.
The term “AI/ML model” may involve model training and model inference. The model training and the model inference may be considered as deployed jointly at NW and UE. It does not preclude AI/ML model training/inference is deployed at NW/UE/operations and maintenance (OAM). If those functions are located in one network entity, a virtual counterpart may be considered, for example, if model training is at NW, virtual UEs may be simulated in training.
The term “data collection” may be a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, output from an AI/ML model.
The term “training data” may be data needed as input for the AI/ML Model Training function.
The term “inference data” may be data needed as input for the AI/ML Model Inference function.
The term “model training” may refer to a function that performs the ML model training, validation, and testing which may generate model performance metrics as part of the model testing procedure. The Model Training function is also responsible for data preparation (e.g. data pre-processing and cleaning, formatting, and transformation) based on Training Data delivered by a Data Collection function, if required.
The term “model inference” may refer to a function that provides AI/ML model inference output (e.g. predictions or decisions). The Model inference function is also responsible for data preparation (e.g. data pre-processing and cleaning, formatting, and transformation) based on Inference Data delivered by a Data Collection function, if required.
The term “actor” may refer to a function that receives the output from the Model inference function and triggers or performs corresponding actions. The Actor may trigger actions directed to other entities or to itself.

Principles and implementations of the present disclosure will be described in detail below with reference to the figures.

### Example of Communication Network

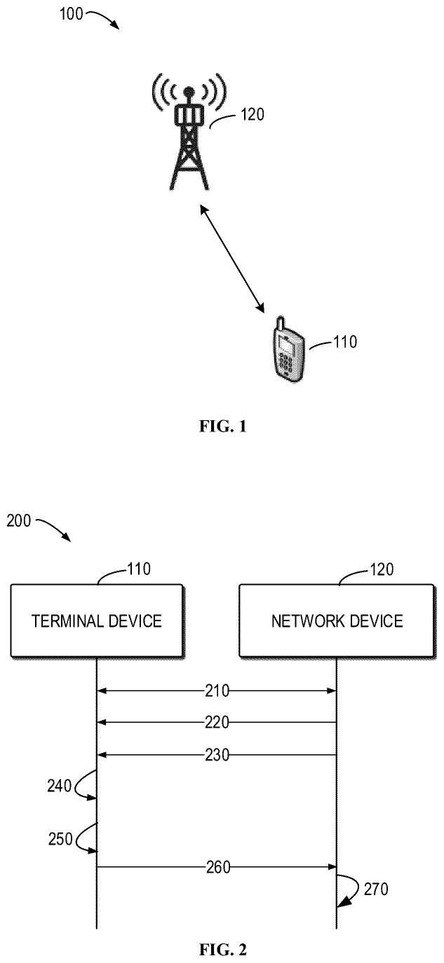

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the network device 120 may provide a serving cell (also referred to as a cell herein), and the terminal device 110 may be located in the cell and may be served by the network device 120. It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with the network device 120 via a channel such as a wireless communication channel. In some embodiments, the terminal device 110 may communicate with the network device 120 via one or more beam pairs.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the terminal device 110 may receive, from the network device 120, a configuration for CSI measurement and report via a DL control channel transmission. For example, the DL control channel transmission may be a PDCCH transmission. Of course, any other suitable forms are also feasible.

In some embodiments, the terminal device 110 may perform CSI measurement to determine CSI and transmit an uplink control information (UCI), e.g., a CSI report to the network device 120 via an UL control channel transmission. For example, the UL control channel transmission may be a PUCCH transmission. Of course, any other suitable forms are also feasible.

In some embodiments, the terminal device 110 may transmit the CSI by a codebook based CSI feedback process. In some embodiments, the codebook based CSI feedback process may be based on type I codebook or type II codebook. In the case of type I codebook, the terminal device 110 may report a single DFT beam for precoding of each layer. In the case of type II codebook, the terminal device 110 may report L (L>1) strongest beams from DFT basis, and use linear combination of the selected beams to construct precoder vectors.

For example, codebook-based CSI may refer to type I single panel codebook, type I multi-panel codebook, type II codebook, type II port selection codebook, enhanced type II codebook, enhanced type II port selection codebook, and further enhanced type II port selection codebook.

In some embodiments, the terminal device 110 may transmit the CSI by an AI or ML based CSI feedback process. In some embodiments, the AI or ML based CSI feedback process may be based on an autoencoder. The autoencoder is a type of artificial neural network used to learn efficient codings of unlabeled data (unsupervised learning). The encoding is validated and refined by attempting to regenerate the input from the encoding. The autoencoder learns a representation (encoding) for a set of data, typically for dimensionality reduction, by training the network to ignore insignificant data (“noise”). In some alternative embodiments, the AI or ML based CSI feedback process may be based on a transformer. The transformer is a deep learning model that adopts a mechanism of attention, differentially weighting significance of each part of an input. Of course, the AI or ML based CSI feedback process may adopt any other suitable schemes existing or to be developed in future.

FIG. 2 illustrates a schematic diagram illustrating an example process 200 of an AI or ML based CSI feedback in which some embodiments of the present disclosure can be implemented. For the purpose of discussion, the process 200 will be described with reference to FIG. 1. The process 200 may involve the terminal device 110 and the network device 120 as illustrated in FIG. 1. It is to be understood that the steps and the order of the steps in FIG. 2 are merely for illustration, and not for limitation. For example, the order of the steps may be changed. Some of the steps may be omitted or any other suitable additional steps may be added.

With reference to FIG. 2, the terminal device 110 may transfer 210 information of UE capability with the network device 120. For example, the network device 120 may transmit, to the terminal device 110, a radio resource control (RRC) configuration regarding an UE capability report. The terminal device 110 may report capability of the terminal device 110 to the network device 120 based on the RRC configuration.

The information of UE capability may comprise AI/ML capability on NW or UE side, for example, a supported AI/ML model, algorithm, size or dimension, computational power or complexity or time. Assuming that AI/ML model training may be carried out on NW or UE or OAM side.

Continue to refer to FIG. 2, the network device 120 may transmit 220, to the terminal device 110, a RRC (re) configuration message to configure a CSI report. For example, information configured by the RRC (re) configuration message may comprise a CSI report configuration and an AI/ML model configuration.

The network device 120 may transmit 230, to the terminal device 110, CSI-RS(s) for a channel measurement. The terminal device 110 may perform 240 the channel measurement by measuring CSI-RS(s) to determine CSI. In some embodiments, the terminal device 110 may determine information of a channel matrix as CSI. In this way, an explicit CSI feedback may be achieved. In some embodiments, the terminal device 110 may determine information of a precoding matrix (for example, PMI) as CSI. In this way, an implicit CSI feedback may be achieved.

The terminal device 110 may compress 250 the CSI by an encoding procedure. Then the terminal device 110 may transmit 260 the compressed CSI to the network device 120 via UCI but in compressed bits.

Upon reception of the compressed CSI, the network device 120 may recovery 270 CSI from the compressed bits by a decoding procedure. Then the CSI may be used for any suitable further processes.

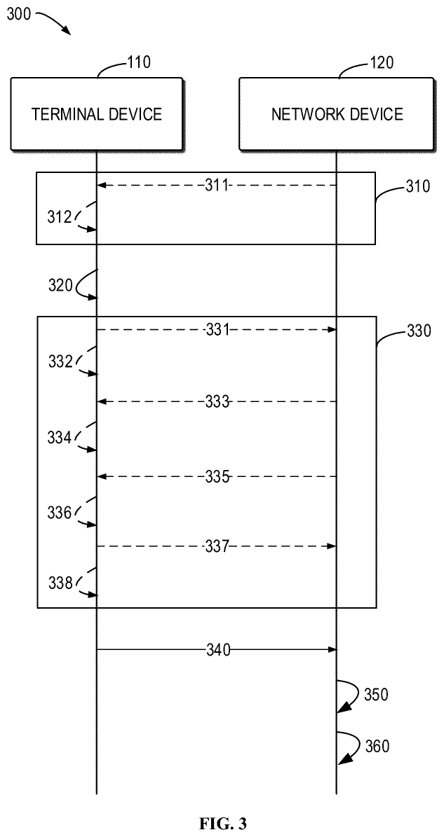

Embodiments of the present disclosure provide a solution for a CSI feedback to exchange information required to align parameters of encoder and decoder, to support adaptive compression method and to design UCI format for compressed CSI feedback. The detailed description will be made with reference to FIG. 3 below.

### Example Implementation of CSI Feedback

FIG. 3 illustrates a schematic diagram illustrating a process 300 of communication according to embodiments of the present disclosure. For the purpose of discussion, the process 300 will be described with reference to FIG. 1. The process 300 may involve the terminal device 110 and the network device 120 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added.

As shown in FIG. 3, the terminal device 110 determines 310 CSI based on a measurement on a set of reference signal (RSs) from the network device 120. For example, the terminal device 110 may receive 311 the set of RSs from the network device 120. The set of RSs may be a set of CSI-RSs or any other suitable RSs. Then the terminal device 110 may perform 312 a channel measurement based on the set of RSs to obtain the CSI.

In some embodiments, the CSI may comprise at least information of a precoding matrix. For example, the CSI may comprise at least one of PMI or a precoding matrix. As another example, the CSI may comprise a channel matrix. Of course, the CSI may comprise any combination of PMI, a precoding matrix and a channel matrix.

Continue to refer to FIG. 3, the terminal device 110 determines 320 a compression method based on a configuration from the network device 120. In some embodiments, the compression method is an AI or ML based compression. For example, the AI or ML based compression may comprise at least an encoding part of an autoencoder. As another example, the AI or ML based compression may comprise at least an encoding part of a transformer. It is to be understood that the AI or ML based compression may also adopt any other suitable forms.

In some embodiments, the terminal device 110 may determine the compression method by determining a set of compression parameters. In some embodiments, the set of compression parameters may comprise at least one of a CR, the number of quantization bits, or the number of compressed bits. Of course, any other suitable compression parameters are also feasible.

In some embodiments, the terminal device may receive the configuration from the network device 120 in a RRC signaling. Of course, any other suitable ways are also feasible.

In some embodiments, the configuration may be applied for a CSI measurement. In some embodiments, the configuration may be applied for a CSI report. It is to be understood that the configuration may be used for any other suitable purposes.

In some embodiments, the configuration may be time-domain information, for example, a time-domain parameter. In some embodiments, the configuration may be frequency-domain information, for example, a frequency-domain parameter. In some embodiments, the configuration may be spatial-domain information, for example, a spatial-domain parameter.

For illustration, some example embodiments on the determination of the compression method will be described below in connection with Embodiments 1 to 3.

### Embodiment 1

In this embodiment, the terminal device 110 may determine the compression method based on time-domain information. The time-domain information may comprise one or more time-domain parameters.

In some embodiments, a time-domain parameter may comprise a periodicity of the set of RSs. In some embodiments, a time-domain parameter may comprise a periodicity of the transmission of the compressed CSI. In some embodiments, a time-domain parameter may comprise a time interval between two transmission occasions of the set of RSs. In some embodiments, a time-domain parameter may comprise a time interval between two transmissions of the compressed CSI. In some embodiments, a time-domain parameter may comprise a time-domain density. In some embodiments, a time-domain parameter may comprise a restriction for the measurement. In some embodiments, a time-domain parameter may comprise coherent time information. In some embodiments, a time-domain parameter may comprise sleep time or inactive time or discontinuous reception (DRX) information. It is to be noted that the time-domain parameter may comprise any other suitable information.

In some embodiments, the terminal device 110 may determine the compression method based on a relationship between the compression method and the time-domain information. In this way, the information about applied compression method is not needed to be exchanged between NW and UE.

For example, the terminal device 110 may determine a set of compression parameter values based on at least one of the following: a mapping between a value of the time-domain parameter and at least one compression parameter value in the set of compression parameter values, or a mapping among at least two compression parameter values in the set of compression parameter values.

In some embodiments, the relationship may be predefined. In some embodiments, the relationship may be configured via NW signaling. In some embodiments, the relationship may be reported as UE capability or suggestion.

In some embodiments, the relationship may be expressed as a step or piecewise function, or a predefined look-up table, or via explicitly signaling describing each entry, or a combination of those mentioned. The entry means a correspondence between a compression parameter value and a time-domain parameter value. Of course, the relationship may also be expressed in any other suitable forms.

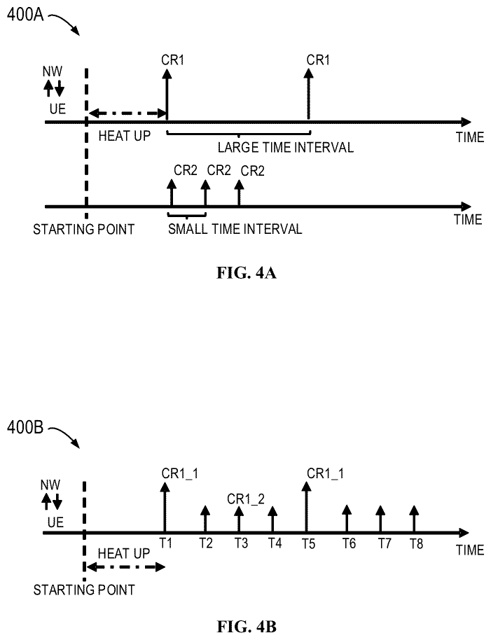

For example, the relationship may be a relationship between periodicity and CR, a relationship between time interval and CR, a relationship between periodicity and the number of quantization bits, etc., FIG. 4A illustrates a schematic diagram 400A illustrating an example determination of a compression method according to embodiments of the present disclosure. In this example, a time interval of RS or CSI report is taken as an example of a time-domain parameter and CR is taken as an example of compression parameter. As shown in FIG. 4A, a larger time interval corresponds to CR1 and a smaller time interval corresponds to CR2. In other words, CR1 is applied for a larger time interval and CR2 is applied for a smaller time interval. Here, CR1 is a lower CR than CR2.

In FIG. 4A, heat up time is shown. During the heat up time, the terminal device 110 may report, the network device 120, explicit CSI, implicit CSI, codebook-based CSI, compressed CSI or a difference among them. Of course, the heat up time is optional. The heat up time may be used to verify AI/ML model performance.

Some examples of the relationship between the compression method (e.g., compression parameter) and the time-domain information (e.g., time-domain parameter) are shown in Tables 1 to 4 below by taking a CR as an example of a compression parameter and a RS or report periodicity as an example of a time-domain parameter. It is to be understood that Tables 1 to 4 are merely examples and are not intended for limitation.

TABLE 1
Example Mapping between Periodicity and CR

| RS or report periodicity | Compression ratio |
|---|---|
| P ≥ P_1 | CR1 |
| P_1 > P ≥ P_2 | CR2 |
| P_2 > P ≥ P_3 | CR3 |
| . . . | . . . |

TABLE 2
Example Mapping between Periodicity and CR

| RS or report periodicity | Compression ratio |
|---|---|
| P ≥ P_1 | No compression |
| P_1 > P ≥ P_2 | CR1 |
| P_2 > P ≥ P_3 | CR2 |
| . . . | . . . |

TABLE 3
Example Mapping between Periodicity and CR

| RS or report periodicity | Compression ratio |
|---|---|
| P ≥ P_1 | CR1 |
| P_1 > P ≥ P_2 | CR2 |
| P_2 > P ≥ P_3 | CR3 |
| . . . | . . . |
| P_(k − 1) > P | CRk |

TABLE 4
Example Mapping between Periodicity and CR

| RS or report periodicity | Compression ratio |
|---|---|
| P ≥ P_1 | (CR1_1, CR1_2) |
| P_1 > P ≥ P_2 | (CR2_1, CR2_2) |
| P_2 > P ≥ P_3 | (CR3_1, CR3_2) |
| . . . | . . . |
| P_(k − 1) > P | (CRk_1, CRk_2) |

In Tables 1 to 4, CR1>CR2> . . . >CRk in terms of fractional number value. For example, CR1 has the lowest compression ratio 1/2, CR2 has compression ratio 1/4, CR3 has compression ratio 1/8, and so on. P denotes a RS or report periodicity. P_1, P_2, . . . , P_(k−1) denote the thresholds/ranges of P to apply different CRs, and may be predefined, be signaled by NW, or be reported as UE capability or suggestion. For example, a threshold of P may be equal to coherent time. Alternatively, a threshold of P may be equal to sleep time or inactive time or DRX information. It is to be understood that these are merely examples, and any other suitable ways are also feasible for the thresholds/ranges of P.

In some embodiments, if a value of the time-domain parameter is below a first threshold value, the terminal device 110 may determine a fixed compression method (also referred to as a first predetermined compression method herein) as the compression method. In some embodiments, if a value of the time-domain parameter is below a second threshold value, the terminal device 110 may determine that no compression is applied. In some embodiments, if a value of the time-domain parameter is above a third threshold value, the terminal device 110 may determine a fixed compression method (also referred to as a second predetermined compression method herein) as the compression method.

As shown in Table 1, if P is greater than or equal to P_1, CR1 is determined as CR. In other words, different CRs are used for different periodicity ranges, and for P greater than or equal to a predetermined P (e.g., P_1), the same low CR is used. As shown in Table 2, if P is greater than or equal to P_1, no compression is done. As shown in Table 3, if P is smaller than P_(k−1), CRk is determined as CR, i.e., the same high CR is used.

In some embodiments, multiple compression methods may be defined for the same time-domain parameter. In some embodiments, the terminal device 110 may select one of the multiple compression methods based on a configuration or an indication from the network device 120. In some embodiments, the terminal device 110 may select one of the multiple compression methods based on UE capability or category. In some embodiments, the terminal device 110 may select one of the multiple compression methods in a default way.

As shown in Table 4, multiple CRs are defined for the same threshold or range, which can be further selected via NW configuration or UE capability/suggestion. Assuming that CR1_1>CR1_2. CR1_2 and CR1_1 may be used for supporting high-end and low-end UE with different AI/ML model (e.g., encoding) capabilities respectively. Alternatively, a default value may also be assumed to be used, for example, the highest/lowest/first/last one of the multiple CRs may be assumed to be used.

In some embodiments, a compression method applied for the n-th CSI report may depend on a compression method applied for one or more of the (n-k)-th CSI report, where n and k are integers and n>k.

In some embodiments, multiple compression methods may be applied for one CSI report configuration. For example, the network device 120 may configure multiple compression methods to be used at different time or report occasions, and the terminal device 110 may use the multiple compression methods at the different time or report occasions. FIG. 4B illustrates a schematic diagram 400B illustrating another example determination of a compression method according to embodiments of the present disclosure. In this example, CR is taken as an example of compression parameter. As shown in FIG. 4B, CR1_1 is used at time or report occasions T1 and T5, and CR1_2 is used at time or report occasions T2, T3, T4, T6, T7 and T8.

In some embodiments, multiple compression methods may be predefined or configured by the network device 120. For illustration, an example of a relationship between time-domain information and multiple compression methods is shown in Table 5 below by taking a CR as an example of a compression parameter and a RS or report periodicity as an example of a time-domain parameter.

TABLE 5
Example Mapping between Periodicity and CRs

| RS or report periodicity | Compression ratio |
|---|---|
| P ≥ P_1 | (CR1_1, CR1_2) |
| P_1 > P ≥ P_2 | (CR2_1, CR2_2) |
| P_2 > P ≥ P_3 | (CR3_1, CR3_2) |
| . . . | . . . |
| P_(k − 1) > P | (CRk_1, CRk_2) |

As shown in Table 5, multiple CRs are defined for the same threshold or range, which may be further selected via NW configuration or via UE capability or category. For example, CR1_1>CR1_2. It is to be understood that Table 5 is merely an example, and is not intended for limitation.

In some embodiments, each compression method may be associated with one time-domain behavior. In other words, a compression method (also referred to as a first compression method herein) may be applied for a time-domain behavior (also referred to as a first time-domain behavior herein) and another compression method (also referred to as a second compression method herein) may be applied for another time-domain behavior (also referred to as a second time-domain behavior herein). As shown in FIG. 4B, CR1_1 is applied every P time units, and CR1_2 is applied every P/t time units excluding every P time units, where P is a configured periodicity for RS or CSI report, and t is a predefined value. For example, t is known at both NW and UE sides via a predefined method, via a configuration or via a UE capability report or suggestion. In some embodiments, t may be 2, 4, 8 or any other suitable integers. In some embodiments where t is an integer, CR1_1 is a lower CR that CR1_2. In some embodiments, t may be ½, ¼, ⅛ or any other suitable fractions. In some embodiments where t is a fraction, CR1_1 is a higher CR that CR1_2. It is to be understood that the time-domain behavior may also adopt any other suitable forms.

In some embodiments, a compression method may be specifically used for a compression in time-domain.

In some embodiments, if “timeRestrictionForChannelMeasurements” or “timeRestrictionForInterferenceMeasurements” is configured, time-domain correlation is not exploited and a lower CR (i.e., more bits for compressed CSI) may be needed than the CR applied if time restriction is not configured. In this way, an impact of time restriction for measurements is considered.

Thus, this embodiment supports or facilitates applying a dynamic compression method to obtain the compressed CSI feedback based on time-domain information. A higher CR, less compressed bits and/or less quantization bits may be determined for a more frequent CSI measurement or report.

### Embodiment 2

In this embodiment, the terminal device 110 may determine the compression method based on frequency-domain information. The frequency-domain information may comprise one or more frequency-domain parameters.

In some embodiments, a frequency-domain parameter may comprise a size of a sub-band. In some embodiments, a frequency-domain parameter may comprise the number of sub-bands. In some embodiments, a frequency-domain parameter may comprise a bandwidth for RS measurement. In some embodiments, a frequency-domain parameter may comprise the number of physical resource blocks (PRBs) in a configured bandwidth part (BWP). In some embodiments, a frequency-domain parameter may comprise a frequency-domain density. In some embodiment, a frequency-domain parameter may comprise a coherent bandwidth. In some embodiment, a frequency-domain parameter may comprise the number of frequency-domain DFT vectors used in the codebook-based CSI feedback. In some embodiments, a frequency-domain parameter may comprise frequency range information, for example, frequency range 1 or frequency range 2. In some embodiments, a frequency-domain parameter may comprise a size or difference of frequency separation. It is to be noted that the frequency-domain parameter may comprise any other suitable information or a combination of these information.

In some embodiments, the terminal device 110 may determine the compression method based on a relationship between the compression method and the frequency-domain information. In this way, the information about applied compression method is not needed to be exchanged between NW and UE.

For example, the terminal device 110 may determine a set of compression parameter values based on at least one of the following: a mapping between a value of the frequency-domain parameter and at least one compression parameter value in the set of compression parameter values, or a mapping among at least two compression parameter values in the set of compression parameter values, or a mapping among at least two frequency-domain parameter values in a set of frequency-domain parameter values.

In some embodiments, the relationship may be predefined. In some embodiments, the relationship may be configured via NW signaling. In some embodiments, the relationship may be reported as UE capability or suggestion.

In some embodiments, the relationship may be expressed as a step or piecewise function, or a predefined look-up table, or via explicitly signaling describing each entry, or a combination of those mentioned. The entry means a correspondence between a compression parameter value and a frequency-domain parameter value. Of course, the relationship may also be expressed in any other suitable forms.

Some examples of the relationship between the compression method (e.g., compression parameter) and the frequency-domain information (e.g., frequency-domain parameter) are shown in Tables 6 to 9 below by taking a CR as an example of a compression parameter and a sub-band size as an example of a frequency-domain parameter. It is to be understood that Tables 6 to 9 are merely examples and are not intended for limitation.

TABLE 6
Example Mapping between Sub-band Size and CR

| Sub-band size | Compression ratio |
|---|---|
| S ≥ S_1 | CR1 |
| S_1 > S ≥ S_2 | CR2 |
| S_2 > S ≥ S_3 | CR3 |
| . . . | . . . |

TABLE 7
Example Mapping between Sub-band Size and CR

| Sub-band Size | Compression ratio |
|---|---|
| S ≥ S_1 | No compression |
| S_1 > S ≥ S_2 | CR1 |
| S_2 > S ≥ S_3 | CR2 |
| . . . | . . . |

TABLE 8
Example Mapping between Sub-band Size and CR

| Sub-band Size | Compression ratio |
|---|---|
| S ≥ S_1 | CR1 |
| S_1 > S ≥ S_2 | CR2 |
| S_2 > S ≥ S_3 | CR3 |
| . . . | . . . |
| S_(k − 1) > S | CRk |

TABLE 9
Example Mapping between Sub-band Size and CR

| Sub-band Size | Compression ratio |
|---|---|
| S ≥ S_1 | (CR1_1, CR1_2) |
| S_1 > S ≥ S_2 | (CR2_1, CR2_2) |
| S_2 > S ≥ S_3 | (CR3_1, CR3_2) |
| . . . | . . . |
| S_(k − 1) > S | (CRk_1, CRk_2) |

In Tables 6 to 9, CR1>CR2> . . . >CRk in terms of fractional number value. For example, CR1 has the lowest compression ratio 1/2, CR2 has compression ratio 1/4, CR3 has compression ratio 1/8, and so on. S denotes a sub-band size. S_1, S_2, . . . , S_(k−1) denote the thresholds/range of S to apply different CRs, and may be predefined, be signaled by NW, or be reported as UE capability or suggestion. For example, a threshold of S may be equal to a coherent bandwidth. It is to be understood that this is merely an example, and any other suitable ways are also feasible for the thresholds/ranges of S.

In some embodiments, if a value of the frequency-domain parameter is below a fourth threshold value, the terminal device 110 may determine a fixed compression method (also referred to as a third predetermined compression method herein) as the compression method. In some embodiments, if a value of the frequency-domain parameter is below a fifth threshold value, the terminal device 110 may determine that no compression is applied. In some embodiments, if a value of the frequency-domain parameter is above a sixth threshold value, the terminal device 110 may determine a fixed compression method (also referred to as a fourth predetermined compression method herein) as the compression method.

As shown in Table 6, if S is greater than or equal to S_1, CR1 is determined as CR. In other words, different CRs are used for different sub-band size ranges, and for S greater than or equal to a predetermined S (e.g., S_1), the same low CR is used. As shown in Table 7, if S is greater than or equal to S_1, no compression is done. As shown in Table 8, if S is smaller than S_(k−1), CRk is determined as CR, i.e., the same high CR is used.

In some embodiments, multiple compression methods may be defined for the same frequency-domain parameter. In some embodiments, the terminal device 110 may select one of the multiple compression methods based on a configuration or an indication from the network device 120. In some embodiments, the terminal device 110 may select one of the multiple compression methods based on UE capability or category. In some embodiments, the terminal device 110 may select one of the multiple compression methods in a default way.

As shown in Table 9, multiple CRs are defined for the same threshold or range, which can be further selected via NW configuration or UE capability/suggestion. Assuming that CR1_1>CR1_2. CR1_2 and CR1_1 may be used for supporting high-end and low-end UE with different AI/ML model (e.g., encoding) capabilities respectively. Alternatively, a default value may also be assumed to be used, for example, the highest/lowest/first/last one of the multiple CRs may be assumed to be used.

In some embodiments, multiple compression methods may be applied for one CSI report configuration. For example, the network device 120 may configure multiple compression methods to be used at different values of a frequency-domain parameter, and the terminal device 110 may use the multiple compression methods for the different values of a frequency-domain parameter.

In some embodiments, the multiple compression methods may be predefined or configured by the network device 120. For illustration, an example of a relationship between frequency-domain information and multiple compression methods is shown in Table 10 below by taking a CR as an example of a compression parameter and a sub-band size as an example of a frequency-domain parameter.

TABLE 10
Example Mapping between Sub-band Size and CR

| Sub-band Size | Compression ratio |
|---|---|
| S ≥ S_1 | (CR1_1, CR1_2) |
| S_1 > S ≥ S_2 | (CR2_1, CR2_2) |
| S_2 > S ≥ S_3 | (CR3_1, CR3_2) |
| . . . | . . . |
| S_(k − 1) > S | (CRk_1, CRk_2) |

As shown in Table 10, multiple CRs are defined for the same threshold or range, which may be further selected via NW configuration or via UE capability or category. For example, CR1_1>CR1_2. It is to be understood that Table 10 is merely an example, and is not intended for limitation.

In some embodiments, each compression method may be associated with a value of a frequency-domain parameter. In other words, a compression method (also referred to as a third compression method herein) may be applied for a value (also referred to as a first value herein) of the frequency-domain parameter and another compression method (also referred to as a fourth compression method herein) may be applied for another value (also referred to as a second value herein) of the frequency-domain parameter. For example, the network device 120 may set one compression method for a wideband and another compression method for a sub-band.

In some embodiments, when an AI or ML based CSI feedback is enabled, a finer sub-band may be supported. For example, UE may be configured via higher layer signaling with one out of two possible sub-band sizes, where a sub-band is defined as Nprb contiguous PRBs and depends on the total number of PRBs in the BWP according to Table 11. In some embodiments, if an AI or ML model based CSI report is activated, a sub-band size may be determined as the lower Nprb value and depend on the total number of PRBs in the BWP according to Table 11. In some embodiments, if an AI or ML model based CSI report is activated, a sub-band size may be determined by a higher-level parameter (for example, subbandSize_AI) and the total number of PRBs in the BWP configured according to Table 12.

TABLE 11
Example Mapping between Sub-band Size and Number of PRBs

| Bandwidth part (PRBs) | Sub-band Size (PRBs) |
|---|---|
| 24-72 | 4, 8 |
| 73-144 | 8, 16 |
| 145-275 | 16, 32 |

TABLE 12
Example Mapping between Sub-band Size and Number of
PRBs if AI or ML Model based CSI Report is Activated

| Bandwidth part (PRBs) | Sub-band Size (PRBs) |
|---|---|
| Range 1 (e.g., 24-72) | 2, 4 |
| Range 2 (e.g., 73-144) | 4, 8 |
| Range 3 (e.g., 145-275) | 8, 16 |
| . . . | . . . |

It is to be understood that Tables 11 and 12 are merely examples, and any other suitable forms are also feasible.

In some embodiments, a compression method may be specifically used for a compression in frequency-domain.

Thus, this embodiment supports or facilitates applying a dynamic compression method to obtain the compressed CSI feedback based on frequency-domain information. A higher CR may be determined for a smaller sub-band size. A higher CR may be determined for a larger number of sub-bands. Less compressed bits per sub-band may be determined for a smaller sub-band size.

### Embodiment 3

In this embodiment, the terminal device 110 may determine the compression method based on spatial-domain information. In some embodiments, the spatial-domain information may comprise beam-domain information. In some embodiments, the spatial-domain information may comprise antenna-port-domain information. In some embodiments, the spatial-domain information may comprise one or more spatial-domain parameters.

In some embodiments, a spatial-domain parameter may comprise the number of antenna ports. In some embodiments, a spatial-domain parameter may comprise the number of panels. In some embodiments, a spatial-domain parameter may comprise an oversampling factor. In some embodiments, a spatial-domain parameter may comprise the number of beams for linear combination. In some embodiments, a spatial-domain parameter may comprise the number of quantized phases. In some embodiments, a spatial-domain parameter may comprise the number of beams. In some embodiments, a spatial-domain parameter may comprise the number of precoders. In some embodiments, a spatial-domain parameter may comprise a codebook type. In some embodiments, a spatial-domain parameter may comprise an antenna structure. In some embodiments, a spatial-domain parameter may comprise polarizations. It is to be noted that the spatial-domain parameter may comprise any other suitable information or combination of information.

In some embodiments, the spatial-domain information may be a function of one or more spatial-domain parameters. In some embodiments, the spatial-domain information may be expressed by equation (1) below.

$$Is = Nbm \qquad ( 1 )$$

where Is denotes the spatial-domain information, and Nbm denotes the total number of beams or (transmit and receive) beam pairs or the number of resources in a resource set configured with “repetition” for beam management.

In some embodiments, the spatial-domain information may be expressed by equation (2) below.

$$Is = N 1 \qquad ( 2 )$$

where Is denotes the spatial-domain information, N1 denotes the number of antenna ports in a vertical antenna layout.

In some embodiments, the spatial-domain information may be expressed by equation (3) below.

$$Is = N 2 \qquad ( 3 )$$

where Is denotes the spatial-domain information, N2 denotes the number of antenna ports in a horizontal antenna layout.

In some embodiments, the spatial-domain information may be expressed by equation (4) below.

$$Is = Ng * N 1 * N 2 \qquad ( 4 )$$

where Is denotes the spatial-domain information, Ng denotes the number of panels, N1 denotes the number of antenna ports in a vertical antenna layout, and N2 denotes the number of antenna ports in a horizontal antenna layout.

In some embodiments, the spatial-domain information may be expressed by equation (5) below.

$$Is = Ng * N 1 O 1 * N 2 O 2 \qquad ( 5 )$$

where Is denotes the spatial-domain information, Ng denotes the number of panels, N1 denotes the number of antenna ports in a vertical antenna layout, N2 denotes the number of antenna ports in a horizontal antenna layout, O1 denotes an oversampling factor in a vertical antenna layout, and O2 denotes an oversampling factor in a horizontal antenna layout.

In some embodiments, the spatial-domain information may be expressed by equation (6) below.

$$Is = Ng * N 1 O 1 * N 2 O 2 / L \qquad ( 6 )$$

where Is denotes the spatial-domain information, Ng denotes the number of panels, N1 denotes the number of antenna ports in a vertical antenna layout, N2 denotes the number of antenna ports in a horizontal antenna layout, O1 denotes an oversampling factor in a vertical antenna layout, O2 denotes an oversampling factor in a horizontal antenna layout, and L denotes the number of beams for linear combination.

In some embodiments, the spatial-domain information may be expressed by equation (7) below.

$$Is = Ng * N 1 O 1 * N 2 O 2 / L * Npsk \qquad ( 7 )$$

where Is denotes the spatial-domain information, Ng denotes the number of panels, N1 denotes the number of antenna ports in a vertical antenna layout, N2 denotes the number of antenna ports in a horizontal antenna layout, O1 denotes an oversampling factor in a vertical antenna layout, O2 denotes an oversampling factor in a horizontal antenna layout, L denotes the number of beams for linear combination, and Npsk denotes the number of quantized phases.

It is to be understood that equations (1) to (7) are merely examples, and any other suitable ways are also feasible.

In some embodiments, the terminal device 110 may determine the compression method based on a relationship between the compression method and the spatial-domain information. In this way, the information about the applied compression method is not needed to be exchanged between NW and UE.

For example, the terminal device 110 may determine a set of compression parameter values based on at least one of the following: a mapping between a value of the spatial-domain parameter and at least one compression parameter value in the set of compression parameter values, or a mapping among at least two compression parameter values in the set of compression parameter values.

In some embodiments, the relationship may be predefined. In some embodiments, the relationship may be configured via NW signaling. In some embodiments, the relationship may be reported as UE capability or suggestion.

In some embodiments, the relationship may be expressed as a step or piecewise function, or a predefined look-up table, or via explicitly signaling describing each entry, or a combination of those mentioned. The entry means a correspondence between a compression parameter value and a spatial-domain parameter value. Of course, the relationship may also be expressed in any other suitable forms.

Some examples of the relationship between the compression method (e.g., compression parameter) and the spatial-domain information (e.g., spatial-domain parameter) are shown in Tables 13 to 16 below by taking a CR as an example of a compression parameter and the number of ports as an example of a spatial-domain parameter. For example, the number of ports may be equal to N1*N2, where N1 denotes the number of antenna ports in a vertical antenna layout, N2 denotes the number of antenna ports in a horizontal antenna layout. Of course, the number of ports may be expressed in any other suitable forms. It is to be understood that Tables 13 to 16 are merely examples and are not intended for limitation.

TABLE 13
Example Mapping between Number of Ports and CR

| Number of ports | Compression ratio |
|---|---|
| N ≥ N_1 | CR1 |
| N_1 > N ≥ N_2 | CR2 |
| N_2 > N ≥ N_3 | CR3 |
| . . . | . . . |

TABLE 14
Example Mapping between Number of Ports and CR

| Number of ports | Compression ratio |
|---|---|
| N ≥ N_1 | No compression |
| N_1 > N ≥ N_2 | CR1 |
| N_2 > N ≥ N_3 | CR2 |
| . . . | . . . |

TABLE 15
Example Mapping between Number of Ports and CR

| Number of ports | Compression ratio |
|---|---|
| N ≥ N_1 | CR1 |
| N_1 > N ≥ N_2 | CR2 |
| N_2 > N ≥ N_3 | CR3 |
| . . . | . . . |
| N_(k − 1) > N | CRk |

TABLE 16
An Example Mapping between Number of Ports and CR

| Number of ports | Compression ratio |
|---|---|
| N ≥ N_1 | (CR1_1, CR1_2) |
| N_1 > N ≥ N_2 | (CR2_1, CR2_2) |
| N_2 > N ≥ N_3 | (CR3_1, CR3_2) |
| . . . | . . . |
| N_(k − 1) > N | (CRk_1, CRk_2) |

In Tables 13 to 16, CR1>CR2> . . . >CRk in terms of fractional number value. For example, CR1 has the lowest compression ratio 1/2, CR2 has compression ratio 1/4, CR3 has compression ratio 1/8, and so on. N denotes the number of ports. N_1, N_2, . . . , N_(k−1) denote the thresholds/range of N to apply different CRs, and may be predefined, be signaled by NW, or be reported as UE capability or suggestion.

In some embodiments, if a value of the spatial-domain parameter is below a seventh threshold value, the terminal device 110 may determine a fixed compression method (also referred to as a fifth predetermined compression method herein) as the compression method. In some embodiments, if a value of the spatial-domain parameter is below an eighth threshold value, the terminal device 110 may determine that no compression is applied. In some embodiments, if a value of the spatial-domain parameter is above a ninth threshold value, the terminal device 110 may determine a fixed compression method (also referred to as a sixth predetermined compression method herein) as the compression method.

As shown in Table 13, if N is greater than or equal to N_1, CR1 is determined as CR. In other words, different CRs are used for different sub-band size ranges, and for N greater than or equal to a predetermined N (e.g., N_1), the same low CR is used. As shown in Table 14, if N is greater than or equal to N_1, no compression is done. As shown in Table 15, if N is smaller than N_(k−1), CRk is determined as CR, i.e., the same high CR is used.

In some embodiments, multiple compression methods may be defined for the same spatial-domain parameter. In some embodiments, the terminal device 110 may select one of the multiple compression methods based on a configuration or an indication from the network device 120. In some embodiments, the terminal device 110 may select one of the multiple compression methods based on UE capability or category. In some embodiments, the terminal device 110 may select one of the multiple compression methods in a default way.

As shown in Table 16, multiple CRs are defined for the same threshold or range, which can be further selected via NW configuration or UE capability/suggestion. Assuming that CR1_1>CR1_2. CR1_2 and CR1_1 may be used for supporting high-end and low-end UE with different AI/ML model (e.g., encoding) capabilities respectively. Alternatively, a default value may also be assumed to be used, for example, the highest/lowest/first/last one of the multiple CRs may be assumed to be used.

In some embodiments, a compression method may be specifically used for a compression in spatial-domain (e.g., antenna-port-domain or beam-domain).

Thus, this embodiment supports or facilitates applying a dynamic compression method to obtain the compressed CSI feedback based on spatial-domain information. A higher CR may be determined for a larger number of antenna ports. Less compressed bits per port may be determined for a larger number of antenna ports.

It is to be understood that Embodiments 1 to 3 may be used in any suitable combination. In addition, when Embodiments 1 to 3 are used in combination, different priorities may be set among time-domain, frequency-domain and spatial-domain information.

Continue to refer to FIG. 3, upon determination of the compression method, the terminal device 110 compresses 330 the CSI based on the compression method. Some example embodiments on the compression of the CSI will be described in connection with Embodiments 4 to 5.

### Embodiment 4

In some embodiments, the terminal device 110 may transmit 331 an indication of the compression method to the network device 120. In this way, the terminal device 110 may report the compression method applied or to be applied. In some embodiments, the terminal device 110 may transmit the indication together with compressed CSI in a CSI report.

In some embodiments, the terminal device 110 may separately transmit the indication via other UL signaling such as UCI, UL medium access control (MAC) control element (CE), PUCCH, PUSCH and so on. In these embodiments, the terminal device 110 may start 332 the compression of the CSI at a predetermined timing after the transmission of the indication.

In some alternative embodiments, the terminal device 110 may receive 333 a confirmation for the indication from the network device 120 and start 334 the compression of the CSI at a predetermined timing after the reception of the confirmation. In some embodiments, the predetermined timing may be X time units, where X≥0.

In some embodiments, the compression method reported by the terminal device 110 may be a suggestion for the network device 120 to update a configuration for the terminal device 110. In some embodiments, the network device 120 may update a time-domain configuration based on the reported compression method and a relationship between the compression method (e.g., compression parameter) and the time-domain information (e.g., time-domain parameter). For example, the network device 120 may configure a larger or smaller periodicity of CSI measurement or report for the terminal device 110.

In some embodiments, the network device 120 may update a frequency-domain configuration based on the reported compression method and a relationship between the compression method (e.g., compression parameter) and the frequency-domain information (e.g., frequency-domain parameter). For example, the network device 120 may configure more or less sub-bands, PRBs, or a larger or smaller sub-band size for CSI measurement or report for the terminal device 110.

In some embodiments, the network device 120 may update an antenna-port-domain configuration based on the reported compression method and a relationship between the compression method (e.g., compression parameter) and the spatial-domain information (e.g., spatial-domain parameter). For example, the network device 120 may configure more or less ports for CSI measurement or report for the terminal device 110.

In some embodiments, the network device 120 may update a beam-domain configuration based on the reported compression method and a relationship between the compression method (e.g., compression parameter) and the spatial-domain information (e.g., spatial-domain parameter). For example, the network device 120 may configure more or less resources for CSI measurement or report for the terminal device 110.

In some embodiments, the network device 120 may update a resource for the transmission of the CSI based on the reported compression method. For example, the network device 120 may assign more or less PUSCH or PUCCH resources for the terminal device 110.

In some embodiments, the network device 120 may update a format for the transmission of the compressed CSI based on the reported compression method. For example, the network device 120 may indicate more bits to report compressed CSI or indicate whether sub-band information is reported.

### Embodiment 5

In some embodiments, the network device 120 may transmit 335 an indication of the compression method to the terminal device 110. In this way, the network device 120 may configure or indicate the compression method applied or to be applied. In some embodiments, the network device 120 may transmit the indication via signaling scheduling, assignment, grant or configured grant which comprises information about modulation and/or coding scheme. In some embodiments, the configuration or indication may be carried via RRC, MAC CE or DCI. For example, the configuration or indication may be carried via a MCS field in DCI. In this way, the compression method may be implicitly configured or indicated to the terminal device 110. In some alternative embodiments, the network device 120 may transmit the indication directly via RRC, MAC CE or DCI. In this way, the compression method may be explicitly configured or indicated to the terminal device 110.

In these embodiments, the terminal device 110 may start 336 the compression of the CSI at a predetermined timing after the reception of the indication. In some alternative embodiments, the terminal device 110 may transmit 337 an acknowledgement (ACK) for the indication to the network device 120 and start 338 the compression of the CSI at a predetermined timing after the transmission of the ACK. In some embodiments, the predetermined timing may be Y time units, where Y>0.

Continue to refer to FIG. 3, upon compression of the CSI, the terminal device 110 transmits 340 the compressed CSI to the network device 120. In some embodiments where CR and quantization information are configured by NW, CSI fields in a CSI report may be designed as shown in Table 17.

TABLE 17
Example of CSI fields in CSI Report

| CSI fields | bitwidth |
|---|---|
| Compressed CSI | Nbits |
| Other information | . . . |

Alternatively, Nbits in Table 17 may be the maximum number of bits for compressed CSI. For those compressed CSI with the number of bits smaller than Nbits, the terminal device 110 may pad zero to the compressed bits so as to become Nbits.

In some embodiments, the terminal device 110 may report the applied compression method (e.g., a set of compression parameters) together with the compressed CSI. For convenience, the following description will be given by taking a CR and quantization information as examples of the set of compression parameters.

In some embodiments, the terminal device 110 may explicitly report CR and implicitly report quantization information. In some embodiments, Table 18 below may be used.

TABLE 18
Example of CSI fields in CSI Report

| CSI fields | bitwidth |
|---|---|
| Compression ratio | K_CR |
| Compressed CSI | Nbits |
| Other information | . . . |

In Table 11, K_CR denotes the number of bits to indicate the applied compression ratio. K_CR may depend on the number of configured or supported CRs (denoted as N_CR), for example, K_CR=ceil (log 2 (N_CR)). It is to be understood that this equation is merely an example, any other suitable ways are also feasible. In this embodiment, quantization information may be determined implicitly by CR as described in Tables 1 to 4.

In some embodiments, the terminal device 110 may explicitly report quantization information and implicitly report CR. In some embodiments, Table 19 below may be used.

TABLE 19
Example of CSI fields in CSI Report

| CSI fields | bitwidth |
|---|---|
| Quantization method | k_q |
| Compressed PMI | Nbits |
| Other information | . . . |

In Table 12, k_q denotes the number of bits to quantize one element of encoder output dimension. k_q may depend on the number of configured or supported quantization methods (denoted as N_q), for example, k_q=ceil (log 2 (N_q)). It is to be understood that this equation is merely an example, any other suitable ways are also feasible. In this embodiment, CR may be determined implicitly by quantization information as described in Tables 1 to 4.

In some embodiments, the terminal device 110 may explicitly report CR and quantization information. In some embodiments, Table 20 below may be used.

TABLE 20
Example of CSI fields in CSI Report

| CSI fields | bitwidth |
|---|---|
| Quantization method | k_q |
| Compression ratio | k_CR |
| Compressed PMI | Nbits |
| Other information | . . . |

In Tables 17 to 20, “Other information” may be other CSI including one or more of CRI, RI, LI, PMI, CQI, etc., Tables 17 to 20 only show one entry per each quantity, and the reporting content may be per codeword, per transport block (TB), per UE panel, per transmission and reception point (TRP), per rank and so on. The same one of different compression methods may be applied per codeword, per TB, per UE panel, per TRP, per rank and so on. It is to be understood that Tables 17 to 20 are merely examples, and are not intended for limitation.

In some embodiments, if no compression is applied, a codebook based CSI feedback may be used instead. Alternatively, a special status all 0 or all 1 is reported as the compressed bits.

Continue to refer to FIG. 3, upon reception of the CSI report comprising the compressed CSI and the channel quality information, the network device 120 determines 350 the compression method applied to the compress CSI based on the configuration comprising at least one of the time-domain, frequency-domain or spatial-domain information. The determination of the compression method at the network device 120 is similar with the determination 320 of the compression method at the terminal device 110 as described above, and thus is not repeated here for concise.

Upon determination of the compression method, the network device 120 recoveries 360 CSI based on the compression method and the compressed CSI. In some embodiments, the recovery may comprise a decoding part of an autoencoder. In some embodiments, the recovery may comprise a decoding part of a transformer.

So far, an AI or ML based CSI feedback according to the present disclosure is described. In this way, a relationship between a compression method and a configuration is defined. An adaptive compression method is supported by considering time-domain or frequency-domain or spatial-domain correlation.

### Example Implementation of Methods

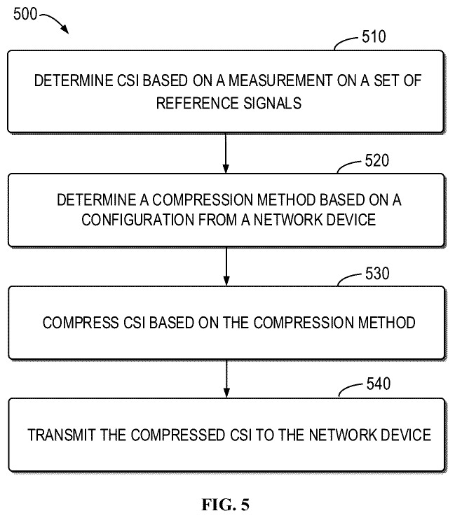

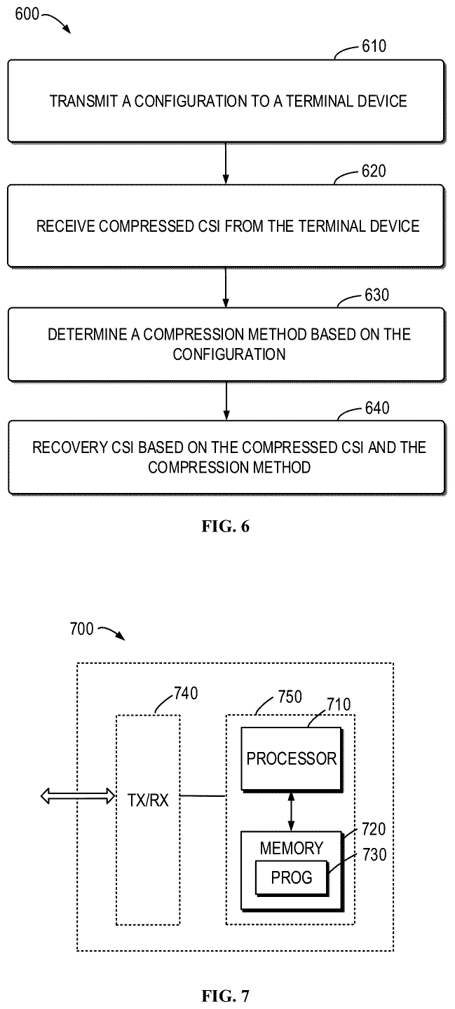

Corresponding to the above process, embodiments of the present disclosure provide methods of communication implemented at a terminal device and a network device. These methods will be described below with reference to FIGS. 5 and 6.

FIG. 5 illustrates an example method 500 of communication implemented at a terminal device in accordance with some embodiments of the present disclosure. For example, the method 500 may be performed at the terminal device 110 as shown in FIG. 1.

For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the terminal device 110 determines CSI based on a measurement on a set of RSs from the network device 120. In some embodiments, the CSI may comprise at least information of a precoding matrix.

At block 520, the terminal device 110 determines a compression method based on a configuration from the network device 120. The configuration comprises at least one of the following: a time-domain parameter, a frequency-domain parameter, or a spatial-domain parameter. In some embodiments, the compression method may be an AI or ML based compression comprising at least an encoding part of an autoencoder or a transformer.

In some embodiments, the terminal device 110 may determine the compression method by determining a set of compression parameter values based on at least one of the following: a mapping between a value of the time-domain parameter and at least one compression parameter value in the set of compression parameter values, or a mapping among at least two compression parameter values in the set of compression parameter values.

In some embodiments, the time-domain parameter may comprise at least one of the following: a periodicity of the set of reference signals, a periodicity of the transmission of the compressed channel state information, a time interval between two transmission occasions of the set of reference signals, a time interval between two transmissions of the compressed channel state information, a time-domain density, or a restriction for the measurement.

In some embodiments, the terminal device 110 may determine a set of compression methods based on the time-domain parameter and determine the compression method from the set of compression methods.

In some embodiments, if a value of the time-domain parameter is below a first threshold value, the terminal device 110 may determine a first predetermined compression method as the compression method. In some embodiments, if a value of the time-domain parameter is below a second threshold value, the terminal device 110 may determine that no compression is applied. In some embodiments, if a value of the time-domain parameter is above a third threshold value, the terminal device 110 may determine a second predetermined compression method as the compression method.

In some embodiments, the terminal device 110 may determine a set of compression methods based on the time-domain parameter. In these embodiments, the terminal device 110 may compress the CSI by: applying a first compression method in the set of compression methods for a first time-domain behavior; and applying a second compression method in the set of compression methods for a second time-domain behavior.

In some embodiments, the terminal device 110 may determine the compression method by: determining a set of compression parameter values based on at least one of the following: a mapping between a value of the frequency-domain parameter and at least one compression parameter value in the set of compression parameter values, a mapping among at least two compression parameter values in the set of compression parameter values, or a mapping among at least two frequency-domain parameter values in a set of frequency-domain parameter values.

In some embodiments, the frequency-domain parameter may comprise at least one of the following: a size of a sub-band, the number of sub-bands, a bandwidth for the measurement, the number of physical resource blocks, or a frequency-domain density.

In some embodiments, the terminal device 110 may determine a set of compression methods based on the frequency-domain parameter, and determine the compression method from the set of compression methods.

In some embodiments, if a value of the frequency-domain parameter is below a fourth threshold value, the terminal device 110 may determine a third predetermined compression method as the compression method. In some embodiments, if a value of the frequency-domain parameter is below a fifth threshold value, the terminal device 110 may determine that no compression is applied. In some embodiments, if a value of the frequency-domain parameter is above a sixth threshold value, the terminal device 110 may determine a fourth predetermined compression method as the compression method.

In some embodiments, the terminal device 110 may determine a set of compression methods based on the frequency-domain parameter. In these embodiments, the terminal device 110 may compress the channel state information by: applying a third compression method in the set of compression methods for a first value of the frequency-domain parameter; and applying a fourth compression method in the set of compression methods for a second value of the frequency-domain parameter.

In some embodiments, the terminal device 110 may determine the compression method by determining a set of compression parameter values based on at least one of the following: a mapping between a value of the spatial-domain parameter and at least one compression parameter value in the set of compression parameter values, or a mapping among at least two compression parameter values in the set of compression parameter values.

In some embodiments, the spatial-domain parameter may comprise at least one of the following: the number of antenna ports, the number of panels, an oversampling factor, the number of beams for linear combination, the number of phase quantization bits, the number of beams, a codebook type, an antenna structure, or polarizations.

In some embodiments, the terminal device 110 may determine a set of compression methods based on the spatial-domain parameter, and determine the compression method from the set of compression methods.

In some embodiments, if a value of the spatial-domain parameter is below a seventh threshold value, the terminal device 110 may determine a fifth predetermined compression method as the compression method. In some embodiments, if a value of the spatial-domain parameter is below an eighth threshold value, the terminal device 110 may determine that no compression is applied. In some embodiments, if a value of the spatial-domain parameter is above a ninth threshold value, the terminal device 110 may determine a sixth predetermined compression method as the compression method.

In some embodiments, the set of compression parameter values may comprise at least one of the following: a CR, the number of quantization bits, or the number of compressed bits.

At block 530, the terminal device 110 compresses the CSI based on the compression method.

In some embodiments, the terminal device 110 may transmit, to the network device 120, an indication of the compression method, and start the compressing of the channel state information at a predetermined timing after the transmission of the indication or a reception of a confirmation for the indication.

In some embodiments, the terminal device 110 may receive, from the network device 120, an indication of the compression method, and start the compressing of the channel state information at a predetermined timing after the reception of the indication or a transmission of an acknowledgement for the indication.

At block 540, the terminal device 110 transmits the compressed CSI to the network device 120.

In some embodiments, the terminal device 110 may further transmit, to the network device 120, an indication of the compression method, and receive, from the network device 120, an updated configuration updated based on the compression method. The updated configuration may comprise at least one of the following: a time-domain configuration, a frequency-domain configuration, a spatial-domain configuration, a beam-domain configuration, a resource for the transmission of the compressed CSI, or a format for the transmission of the compressed CSI.

In some embodiments, the terminal device 110 may transmit, to the network device 120, at least one compression parameter in the set of compression parameters.

With the method of FIG. 5, CSI may be compressed based on a compression method determined from a configuration. CSI feedback overhead and compression performance may be balanced.

FIG. 6 illustrates an example method 600 of communication implemented at a network device in accordance with some embodiments of the present disclosure. For example, the method 600 may be performed at the network device 120 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the network device 120 transmits, to the terminal device 110, a configuration comprising at least one of the following: a time-domain parameter, a frequency-domain parameter, or a spatial-domain parameter.

In some embodiments, the time-domain parameter may comprise at least one of the following: a periodicity of the set of RSs, a periodicity of the transmission of the compressed CSI, a time interval between two transmission occasions in the set of RSs, a time interval between two transmissions of the compressed CSI, a time-domain density, or a restriction for the measurement.

In some embodiments, the frequency-domain parameter may comprise at least one of the following: a size of a sub-band, the number of sub-bands, a bandwidth for the measurement, the number of physical resource blocks, or a frequency-domain density.

In some embodiments, the spatial-domain parameter comprises at least one of the following: the number of antenna ports, the number of panels, an oversampling factor, the number of beams for linear combination, the number of phase quantization bits, the number of beams, a codebook type, an antenna structure, or polarizations.

At block 620, the network device 120 receives compressed CSI from the terminal device 110.

At block 630, the network device 120 determines a compression method applied for the compressed CSI based on the configuration. In some embodiments, the compression method may be an AI or ML based compression comprising at least an encoding part of an autoencoder or a transformer.

In some embodiments, the network device 120 may determine the compression method by determining a set of compression parameter values based on at least one of the following: a mapping between the time-domain parameter and at least one compression parameter value in the set of compression parameter values, or a mapping among at least two compression parameter values in the set of compression parameter values.

In some embodiments, the network device 120 may determine a set of compression methods based on the time-domain parameter, and determine the compression method from the set of compression methods.

In some embodiments, if a value of the time-domain parameter is below a first threshold value, the network device 120 may determine a first predetermined compression method as the compression method. In some embodiments, if a value of the time-domain parameter is below a second threshold value, the network device 120 may determine that no compression is applied. In some embodiments, if a value of the time-domain parameter is above a third threshold value, the network device 120 may determine a second predetermined compression method as the compression method.

In some embodiments, the network device 120 may determine a set of compression methods based on the time-domain parameter. In these embodiments, the network device 120 may determine, as the compression method, a first compression method in the set of compression methods for a first value of the time-domain parameter, or determine, as the compression method, a second compression method in the set of compression methods for a second value of the time-domain parameter.

In some embodiments, the network device 120 may determine the compression method by determining a set of compression parameter values based on at least one of the following: a mapping between the frequency-domain parameter and at least one compression parameter value in the set of compression parameter values, a mapping among at least two compression parameter values in the set of compression parameter values, or a mapping between sub-band sizes and the number of PRBs in a BWP.

In some embodiments, the network device 120 may determine a set of compression methods based on the frequency-domain parameter, and determine the compression method from the set of compression methods.

In some embodiments, if a value of the frequency-domain parameter is below a fourth threshold value, the network device 120 may determine a third predetermined compression method as the compression method. In some embodiments, if a value of the frequency-domain parameter is below a fifth threshold value, the network device 120 may determine that no compression is applied. In some embodiments, if a value of the frequency-domain parameter is above a sixth threshold value, the network device 120 may determine a fourth predetermined compression method as the compression method.

In some embodiments, the network device 120 may determine a set of compression methods based on the frequency-domain parameter. In these embodiments, the network device 120 may determine, as the compression method, a third compression method in the set of compression methods for a first value of the frequency-domain parameter, or determine, as the compression method, a fourth compression method in the set of compression methods for a second value of the frequency-domain parameter.

In some embodiments, the network device 120 may determine the compression method by determining a set of compression parameter values based on at least one of the following: a mapping between the spatial-domain parameter and at least one compression parameter value in the set of compression parameter values, or a mapping among at least two compression parameter values in the set of compression parameter values.

In some embodiments, the network device 120 may determine a set of compression methods based on the spatial-domain parameter, and determine the compression method from the set of compression methods.

In some embodiments, if a value of the spatial-domain parameter is below a seventh threshold value, the network device 120 may determine a fifth predetermined compression method as the compression method. In some embodiments, if a value of the spatial-domain parameter is below an eighth threshold value, the network device 120 may determine that no compression is applied. In some embodiments, if a value of the spatial-domain parameter is above a ninth threshold value, the network device 120 may determine a sixth predetermined compression method as the compression method.

At block 640, the network device 120 recoveries CSI based on the compressed CSI and the compression method. In some embodiments, the CSI may comprise at least information of a precoding matrix. In some embodiments, the recovering may comprise at least a decoding part of an autoencoder or a transformer.

In some embodiments, the network device 120 may further transmit, to the terminal device 110, an indication of the compression method.

In some embodiments, the network device 120 may further receive, from the terminal device 110, an indication of the compression method, and update, based on the compression method, a configuration comprising at least one of the following: a time-domain configuration, a frequency-domain configuration, a spatial-domain configuration, a beam-domain configuration, a resource for the transmission of the compressed channel state information, or a format for the transmission of the compressed channel state information. Then the network device 120 may transmit the updated configuration to the terminal device 110.

In some embodiments, the set of compression parameter values may comprise at least one of the following: a compression ratio, the number of quantization bits, or the number of compressed bits.

In some embodiments, the network device 120 may receive, from the terminal device 110, at least one compression parameter in the set of compression parameters.

With the method of FIG. 6, CSI may be recovered from compressed CSI based on a compression method determined from a configuration. CSI feedback overhead and compression performance may be balanced.

### Example Implementation of Device and Apparatus

FIG. 7 is a simplified block diagram of a device 700 that is suitable for implementing embodiments of the present disclosure. The device 700 can be considered as a further example implementation of the terminal device 110 or the network device 120 as shown in FIG. 1. Accordingly, the device 700 can be implemented at or as at least a part of the terminal device 110 or the network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a terminal device comprises a circuitry configured to: determine channel state information based on a measurement on a set of reference signals from a network device; determine a compression method based on a configuration from a network device, the configuration comprising at least one of the following: a time-domain parameter, a frequency-domain parameter, or a spatial-domain parameter; compress the channel state information based on the compression method; and transmit, to the network device, the compressed channel state information.

In some embodiments, the channel state information comprises at least information of a precoding matrix. In some embodiments, the compression method is an artificial intelligence or machine learning based compression comprising at least an encoding part of an autoencoder or a transformer.

In some embodiments, the circuitry may be configured to determine the compression method by determining a set of compression parameter values based on at least one of the following: a mapping between a value of the time-domain parameter and at least one compression parameter value in the set of compression parameter values, or a mapping among at least two compression parameter values in the set of compression parameter values.

In some embodiments, the time-domain parameter comprises at least one of the following: a periodicity of the set of reference signals, a periodicity of the transmission of the compressed channel state information, a time interval between two transmission occasions of the set of reference signals, a time interval between two transmissions of the compressed channel state information, a time-domain density, or a restriction for the measurement.

In some embodiments, the circuitry may be configured to determine the compression method by determining a set of compression methods based on the time-domain parameter; and determining the compression method from the set of compression methods.

In some embodiments, the circuitry may be configured to determine the compression method by: in accordance with a determination that a value of the time-domain parameter is below a first threshold value, determining a first predetermined compression method as the compression method; in accordance with a determination that a value of the time-domain parameter is below a second threshold value, determining that no compression is applied; or in accordance with a determination that a value of the time-domain parameter is above a third threshold value, determining a second predetermined compression method as the compression method.

In some embodiments, the circuitry may be configured to determine the compression method by determining a set of compression methods based on the time-domain parameter. In these embodiments, the circuitry may be configured to compress the channel state information by: applying a first compression method in the set of compression methods for a first time-domain behavior; and applying a second compression method in the set of compression methods for a second time-domain behavior.

In some embodiments, the circuitry may be configured to determine the compression method by determining a set of compression parameter values based on at least one of the following: a mapping between a value of the frequency-domain parameter and at least one compression parameter value in the set of compression parameter values, a mapping among at least two compression parameter values in the set of compression parameter values, or a mapping among at least two frequency-domain parameter values in a set of frequency-domain parameter values.

In some embodiments, the frequency-domain parameter comprises at least one of the following: a size of a sub-band, the number of sub-bands, a bandwidth for the measurement, the number of physical resource blocks, or a frequency-domain density.

In some embodiments, the circuitry may be configured to determine the compression method by: determining a set of compression methods based on the frequency-domain parameter; and determining the compression method from the set of compression methods.

In some embodiments, the circuitry may be configured to determine the compression method by: in accordance with a determination that a value of the frequency-domain parameter is below a fourth threshold value, determining a third predetermined compression method as the compression method; in accordance with a determination that a value of the frequency-domain parameter is below a fifth threshold value, determining that no compression is applied; or in accordance with a determination that a value of the frequency-domain parameter is above a sixth threshold value, determining a fourth predetermined compression method as the compression method.

In some embodiments, the circuitry may be configured to determine the compression method by determining a set of compression methods based on the frequency-domain parameter. In these embodiments, the circuitry may be configured to compress the channel state information by: applying a third compression method in the set of compression methods for a first value of the frequency-domain parameter; and applying a fourth compression method in the set of compression methods for a second value of the frequency-domain parameter.

In some embodiments, the circuitry may be configured to determine the compression method by determining a set of compression parameter values based on at least one of the following: a mapping between a value of the spatial-domain parameter and at least one compression parameter value in the set of compression parameter values, or a mapping among at least two compression parameter values in the set of compression parameter values.

In some embodiments, the spatial-domain parameter comprises at least one of the following: the number of antenna ports, the number of panels, an oversampling factor, the number of beams for linear combination, the number of phase quantization bits, the number of beams, a codebook type, an antenna structure, or polarizations.

In some embodiments, the circuitry may be configured to determine the compression method by: determining a set of compression methods based on the spatial-domain parameter; and determining the compression method from the set of compression methods.

In some embodiments, the circuitry may be configured to determine the compression method by: in accordance with a determination that a value of the spatial-domain parameter is below a seventh threshold value, determining a fifth predetermined compression method as the compression method; in accordance with a determination that a value of the spatial-domain parameter is below an eighth threshold value, determining that no compression is applied; or in accordance with a determination that a value of the spatial-domain parameter is above a ninth threshold value, determining a sixth predetermined compression method as the compression method.

In some embodiments, the circuitry may be configured to compress the channel state information by: transmitting, to the network device, an indication of the compression method; and starting the compressing of the channel state information at a predetermined timing after the transmission of the indication or a reception of a confirmation for the indication.

In some embodiments, the circuitry may be configured to compress the channel state information by: receiving, from the network device, an indication of the compression method; and starting the compressing of the channel state information at a predetermined timing after the reception of the indication or a transmission of an acknowledgement for the indication.

In some embodiments, the circuitry may be further configured to: transmit, to the network device, an indication of the compression method; and receive, from the network device, an updated configuration updated based on the compression method, the updated configuration comprising at least one of the following: a time-domain configuration, a frequency-domain configuration, a spatial-domain configuration, a beam-domain configuration, a resource for the transmission of the compressed channel state information, or a format for the transmission of the compressed channel state information.

In some embodiments, the set of compression parameter values comprises at least one of the following: a compression ratio, the number of quantization bits, or the number of compressed bits.

In some embodiments, the circuitry may be further configured to transmit, to the network device, at least one compression parameter in the set of compression parameters.

In some embodiments, a network device comprises a circuitry configured to: transmit, to a terminal device, a configuration comprising at least one of the following: a time-domain parameter, a frequency-domain parameter, or a spatial-domain parameter; receive compressed channel state information from the terminal device; determine a compression method applied for the compressed channel state information based on the configuration; and recovery channel state information based on the compressed channel state information and the compression method.

In some embodiments, the channel state information comprises at least information of a precoding matrix. In some embodiments, the compression method is an artificial intelligence or machine learning based compression comprising at least an encoding part of an autoencoder or a transformer, and the recovering comprises at least a decoding part of an autoencoder or a transformer.

In some embodiments, the circuitry may be configured to determine the compression method by determining a set of compression parameter values based on at least one of the following: a mapping between the time-domain parameter and at least one compression parameter value in the set of compression parameter values, or a mapping among at least two compression parameter values in the set of compression parameter values.

In some embodiments, the time-domain parameter comprises at least one of the following: a periodicity of the set of reference signals, a periodicity of the transmission of the compressed channel state information, a time interval between two transmission occasions in the set of reference signals, a time interval between two transmissions of the compressed channel state information, a time-domain density, or a restriction for the measurement.

In some embodiments, the circuitry may be configured to determine the compression method by: determining a set of compression methods based on the time-domain parameter; and determining the compression method from the set of compression methods.

In some embodiments, the circuitry may be configured to determine the compression method by: in accordance with a determination that a value of the time-domain parameter is below a first threshold value, determining a first predetermined compression method as the compression method; in accordance with a determination that a value of the time-domain parameter is below a second threshold value, determining that no compression is applied; or in accordance with a determination that a value of the time-domain parameter is above a third threshold value, determining a second predetermined compression method as the compression method.

In some embodiments, the circuitry may be configured to determine the compression method by determining a set of compression methods based on the time-domain parameter. In these embodiments, the circuitry may be configured to determine the compression method by: determining, as the compression method, a first compression method in the set of compression methods for a first value of the time-domain parameter; or determining, as the compression method, a second compression method in the set of compression methods for a second value of the time-domain parameter.

In some embodiments, the circuitry may be configured to determine the compression method by determining a set of compression parameter values based on at least one of the following: a mapping between the frequency-domain parameter and at least one compression parameter value in the set of compression parameter values, a mapping among at least two compression parameter values in the set of compression parameter values, or a mapping between sub-band sizes and the number of physical resource blocks in a bandwidth part.

In some embodiments, the frequency-domain parameter comprises at least one of the following: a size of a sub-band, the number of sub-bands, a bandwidth for the measurement, the number of physical resource blocks, or a frequency-domain density.

In some embodiments, the circuitry may be configured to determine the compression method by: determining a set of compression methods based on the frequency-domain parameter; and determining the compression method from the set of compression methods.

In some embodiments, the circuitry may be configured to determine the compression method by: in accordance with a determination that a value of the frequency-domain parameter is below a fourth threshold value, determining a third predetermined compression method as the compression method; in accordance with a determination that a value of the frequency-domain parameter is below a fifth threshold value, determining that no compression is applied; or in accordance with a determination that a value of the frequency-domain parameter is above a sixth threshold value, determining a fourth predetermined compression method as the compression method.

In some embodiments, the circuitry may be configured to determine the compression method by determining a set of compression methods based on the frequency-domain parameter.

In some embodiments, the circuitry may be configured to determine the compression method by: determining, as the compression method, a third compression method in the set of compression methods for a first value of the frequency-domain parameter; or determining, as the compression method, a fourth compression method in the set of compression methods for a second value of the frequency-domain parameter.

In some embodiments, the circuitry may be configured to determine the compression method by determining a set of compression parameter values based on at least one of the following: a mapping between the spatial-domain parameter and at least one compression parameter value in the set of compression parameter values, or a mapping among at least two compression parameter values in the set of compression parameter values.

In some embodiments, the spatial-domain parameter comprises at least one of the following: the number of antenna ports, the number of panels, an oversampling factor, the number of beams for linear combination, the number of phase quantization bits, the number of beams, a codebook type, an antenna structure, or polarizations.

In some embodiments, the circuitry may be configured to determine the compression method by: determining a set of compression methods based on the spatial-domain parameter; and determining the compression method from the set of compression methods.

In some embodiments, the circuitry may be configured to determine the compression method by: in accordance with a determination that a value of the spatial-domain parameter is below a seventh threshold value, determining a fifth predetermined compression method as the compression method; in accordance with a determination that a value of the spatial-domain parameter is below an eighth threshold value, determining that no compression is applied; or in accordance with a determination that a value of the spatial-domain parameter is above a ninth threshold value, determining a sixth predetermined compression method as the compression method.

In some embodiments, the circuitry may be further configured to transmit, to the terminal device, an indication of the compression method.

In some embodiments, the circuitry may be further configured to: receive, from the terminal device, an indication of the compression method; and update, based on the compression method, a configuration comprising at least one of the following: a time-domain configuration, a frequency-domain configuration, a spatial-domain configuration, a beam-domain configuration, a resource for the transmission of the compressed channel state information, or a format for the transmission of the compressed channel state information; and transmit the updated configuration to the terminal device.

In some embodiments, the set of compression parameter values comprises at least one of the following: a compression ratio, the number of quantization bits, or the number of compressed bits.

In some embodiments, the circuitry may be further configured to receive, from the terminal device, at least one compression parameter in the set of compression parameters.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a terminal device, channel state information based on a measurement on a set of reference signals from a network device;
determining a compression method based on a configuration from a network device, the configuration comprising at least one of the following:
a time-domain parameter,
a frequency-domain parameter, or
a spatial-domain parameter;
compressing the channel state information based on the compression method; and
transmitting, to the network device, the compressed channel state information.

2. The method of claim 1, wherein the channel state information comprises at least information of a precoding matrix.

3. The method of claim 1, wherein the compression method is an artificial intelligence or machine learning based compression comprising at least an encoding part of an autoencoder or a transformer.

4. The method of claim 1, wherein determining the compression method comprises:
determining a set of compression parameter values based on at least one of the following:
a mapping between a value of the time-domain parameter and at least one compression parameter value in the set of compression parameter values, or
a mapping among at least two compression parameter values in the set of compression parameter values.

5. The method of claim 1, wherein the time-domain parameter comprises at least one of the following:
a periodicity of the set of reference signals,
a periodicity of the transmission of the compressed channel state information,
a time interval between two transmission occasions of the set of reference signals,
a time interval between two transmissions of the compressed channel state information,
a time-domain density, or
a restriction for the measurement.

6. The method of claim 1, wherein determining the compression method comprises:
determining a set of compression methods based on the time-domain parameter; and
determining the compression method from the set of compression methods.

7. The method of claim 1, wherein determining the compression method comprises:
in accordance with a determination that a value of the time-domain parameter is below a first threshold value, determining a first predetermined compression method as the compression method;
in accordance with a determination that a value of the time-domain parameter is below a second threshold value, determining that no compression is applied; or
in accordance with a determination that a value of the time-domain parameter is above a third threshold value, determining a second predetermined compression method as the compression method.

8. The method of claim 1, wherein determining the compression method comprises:
determining a set of compression methods based on the time-domain parameter.

9. The method of claim 8, wherein compressing the channel state information comprises:
applying a first compression method in the set of compression methods for a first time-domain behavior; and
applying a second compression method in the set of compression methods for a second time-domain behavior.

10. The method of claim 1, wherein determining the compression method comprises:
determining a set of compression parameter values based on at least one of the following:
a mapping between a value of the frequency-domain parameter and at least one compression parameter value in the set of compression parameter values,
a mapping among at least two compression parameter values in the set of compression parameter values, or
a mapping among at least two frequency-domain parameter values in a set of frequency-domain parameter values.

11. The method of claim 1, wherein the frequency-domain parameter comprises at least one of the following:
a size of a sub-band,
the number of sub-bands,
a bandwidth for the measurement,
the number of physical resource blocks, or
a frequency-domain density.

12. The method of claim 1, wherein determining the compression method comprises:
determining a set of compression methods based on the frequency-domain parameter; and
determining the compression method from the set of compression methods.

13. The method of claim 1, wherein determining the compression method comprises:
in accordance with a determination that a value of the frequency-domain parameter is below a fourth threshold value, determining a third predetermined compression method as the compression method;
in accordance with a determination that a value of the frequency-domain parameter is below a fifth threshold value, determining that no compression is applied; or
in accordance with a determination that a value of the frequency-domain parameter is above a sixth threshold value, determining a fourth predetermined compression method as the compression method.

14. The method of claim 1, wherein determining the compression method comprises:
determining a set of compression methods based on the frequency-domain parameter.

15. The method of claim 14, wherein compressing the channel state information comprises:
applying a third compression method in the set of compression methods for a first value of the frequency-domain parameter; and
applying a fourth compression method in the set of compression methods for a second value of the frequency-domain parameter.

16. The method of claim 1, wherein determining the compression method comprises:
determining a set of compression parameter values based on at least one of the following:
a mapping between a value of the spatial-domain parameter and at least one compression parameter value in the set of compression parameter values, or
a mapping among at least two compression parameter values in the set of compression parameter values.

17. The method of claim 1, wherein the spatial-domain parameter comprises at least one of the following:
the number of antenna ports,
the number of panels,
an oversampling factor,
the number of beams for linear combination,
the number of phase quantization bits,
the number of beams,
a codebook type,
an antenna structure, or
polarizations.

18. The method of claim 1, wherein determining the compression method comprises:
determining a set of compression methods based on the spatial-domain parameter; and
determining the compression method from the set of compression methods.

19-24. (canceled)

25. A method of communication, comprising:
transmitting, at a network device and to a terminal device, a configuration comprising at least one of the following:
a time-domain parameter,
a frequency-domain parameter, or
a spatial-domain parameter;
receiving compressed channel state information from the terminal device;
determining a compression method applied for the compressed channel state information based on the configuration; and
recovering channel state information based on the compressed channel state information and the compression method.

26-47. (canceled)

48. A terminal device, comprising:
a processor configured to cause the terminal device to perform the method according to claim 1.

49. (canceled)
